(19) United States
(12) Patent Application Publication
(10) Pub. No.: US 2009/0043849 A1
(43) Pub. Date: Feb. 12, 2009

(54) COLLABORATIVE WEB-BASED COMPUTING

(75) Inventors: Joshua Blackburn, Newport News, VA (US); Ryan Dietrich, Charleston, SC (US)

Correspondence Address: HOGAN & HARTSON LLP, ONE TABOR CENTER, SUITE 1500, 1200 SEVENTEENTH ST, DENVER, CO, 80202, US

(73) Assignee: Intelligent Software Solutions, Inc., Colorado Springs, CO (US)

(21) Appl. No.: 12/180,148

(22) Filed: Jul. 25, 2008

Related U.S. Application Data
(60) Provisional application No. 60/952,496, filed on Jul. 27, 2007.

(51) Int. Cl. G06F 15/16

(52) U.S. Cl. 709/205

(57) ABSTRACT

A collaborative web-based computing system includes a plurality of client computers interacting with a web-based application server. Interposed between the application server and the plurality of client computers is a communication server employing eXtensible Messaging and Presence Protocols (“XMPP”). A channel is created between one of the client computers and the communications server and thereafter a session with the application server is initiated. Responsive to the creation of a web-based session between at least one client and the application server, other client computers can request to join the session via separate channels with the communication server. Data from the application server is pushed from the application server to each of the client computers simultaneously via the communication server. Client computers do not actively pull information from the communications server but are rather receptive to data that is being pushed down the existing channel.

### RELATED APPLICATION

The present application relates to and claims the benefit of priority to U.S. Provisional Patent Application No. 60/952,496 filed Jul. 27, 2007, which is hereby incorporated by reference in its entirety for all purposes as if fully set forth herein.

### BACKGROUND OF THE INVENTION

1. Field of the Invention

Embodiments of the present invention relate, in general, to collaborative computing and particularly to systems and methods for simultaneous web based collaborative computing.

2. Relevant Background

The Internet is comprised of a vast number of world-wide interconnected computers and computer networks. These interconnected computers exchange information using various services such as electronic mail (“email”), Gopher, telnet, file transfer protocol (“FTP”), and the World Wide Web (“Web”).

Increasingly, business data processing systems, entertainment systems, and personal communications systems are implemented by computers across networks that are interconnected by internetworks (e.g., the Internet). Data exchanges support applications including electronic commerce (e-commerce), broadcast and multicast messaging, videoconferencing, gaming, and the like.

The Internet is generally a collection of heterogeneous computers and networks coupled together by a web of interconnections using standardized communications protocols. The Internet is characterized by its vast reach as a result of its wide and increasing availability and easy access protocols. Unfortunately, the ubiquitous nature of the Internet results in variable bandwidth and quality of service between points. The latency and reliability of data transport is largely determined by the total amount of traffic on the Internet.

Internet protocols, routing mechanisms and address discovery mechanisms do not discriminate between users. Data packets are passed between routers and switches that make up the Internet based on the hardware's instantaneous view of the best path between source and destination nodes specified in the packet. Because each packet may take a different path, the latency of a packet cannot be guaranteed and, in practice, varies significantly.

Traditional collaborative computing tools allow computer users at different locations to communicate via a computer network such as the Internet and share documents or applications stored and/or executed on one of the user's computers. While both peer-to-peer and client-server communication models have been used in the past, web-based collaborative tools generally employ a client-server model.

For example, client-server application sharing (also discussed in the context of “distributed computing”) is described in U.S. Pat. No. 5,434,852 “Distributed Processing Architecture for Control of Broadband and Narrowband Communication Networks;” U.S. Pat. No. 5,887,170 “System for Classifying and Sending Selective Requests . . . ;” and U.S. Pat. No. 6,038,593 “Remote Application Control for Low Bandwidth Application Sharing,” all incorporated herein by reference in their entireties.

FIG. 1 is a block diagram illustrating the communication scheme used for an exemplary traditional collaborative client-server computer system 100 as is known in the prior art. In FIG. 1 client computers 110n (where n=A, B, C . . . ) can connect to server computers 120n over a global-area computer network 130 (e.g., the Internet). As used herein, the numeral n appended to a reference number does not imply any correspondence among elements having different numerals (e.g., client computer 110A bears no relationship to server computer 120A). FIG. 1 also illustrates the communications channels 140 established between client computers 110n and server computers 120n to set up two conferences between users of client computers 110A and 110B on the one end and 110C and 110D on the other. As is readily apparent from inspection of FIG. 1, each conference is handled by a single server computer 120n. This model performs satisfactorily for conferences having a small number of participants and conferences. However, as the number of participants in a conference increases, the computing power of server computer 120n becomes a bottleneck.

Using this type of configuration, the server computer 120n pulls information from a host computer and then pushes it back to the clients waiting to receive information. Similarly, when a client is seeking information, the server 120n acts as an intermediary to pull information from the host and return it to the requesting client. Thus the server can be clearly seen as a weak link in the existing art.

Many systems exist today that allow multiple users or clients to view a document or application on a host computer. Typically a web based application identifies one client as the host and then enables other connected clients to view data present on the host machine. Again the server providing the web application is a critical component. While the control of the web based application can shift from one client to another, the sharing application itself typically remains resident on the server. Generally the data and the application manipulating the data is resident on each client.

The remaining clients constantly interact with the server to pull information with respect to what is occurring on the host. Furthermore, the server acts to pull information from the client while at the same time the hosting client pulls information that may be resident on the server. Thus when a modification is made on the data at the host machine, the data is pulled back to the server. Since new data on the server is available, upon the next inquiry by the other clients the data is conveyed via the pull for data. For example, one protocol called Hypertext Transfer Protocol (“HTTP”) binding allows a client to constantly pull data from a server every time the server possesses new data. This transport protocol emulates a bidirectional stream between two entities (such as a client and a server) by efficiently using multiple synchronous HTTP request/response pairs.

This type of emulation, while seemingly transparent when employed among a relatively few number of clients, is very demanding on the computing and bandwidth capabilities of the hosting server. As more and more clients are added to a session, the demand on the server is increased. Thus a challenge remains to form a collaborative session that is efficiently scalable. Furthermore, the collaborative ability using existing technology continues to be limited. In each session, one client computer dominates the session. Other clients can view what is transpiring at the hosting client, however, unless control of the session is transferred, other clients cannot actively contribute to a session. Thus the data that is being shown during such a session is controlled by one client. When control is transferred, the client gaining control must somehow either gain control of the data independent of the collaborative session or have data transferred from the last controlling client.

For example, consider a web-based collaborative session in which a plurality of clients are viewing a document hosted by one client. Using a web-based application from a server, one client can share a document via an application resident on that client's machine with all other clients participating in the session. As the controlling client makes changes to the document, the data is relayed to each participating client. However, should one of the participating clients wish to take control of the session and make changes to the same document, the originally controlling client must close and save his inputs and then provide the data source to the new host. The prior art lacks the ability to enable multiple clients to concurrently modify the same data source while working in a collaborative session.

### SUMMARY OF THE INVENTION

A system and method for collaborative web-based computing is hereafter disclosed. According to an embodiment of the present invention, a plurality of client computers interact with a web-based application server. Interposed between the application server and the plurality of client computers is a communication server employing, in one embodiment of the present invention, an eXtensible Messaging and Presence Protocol (“XMPP”).

Upon initiation by a client computer, a channel is created between the client computer and the communications server. Once the channel is established, a session with the application server is initiated by the communications server on behalf of the client computer. The application server accesses data from a database independent of the client computer but consistent with the requested service.

Responsive to the creation of a web-based session between at least one client and the application server, other client computers can request to join the session. According to an embodiment of the present invention, each requesting client computer is authenticated and thereafter authorized to join the session. Authorized client computers establish channels with the communication server so as to participate in the ongoing session.

Data from the application server is pushed from the application server to each of the client computers simultaneously via the communication server. Client computers do not actively pull information from the communications server but are rather receptive to data that is being pushed down the existing channel.

According to another embodiment of the present invention, the communication server includes a parser operative to modify data communications between the plurality of client computers and the applications server. The parser examines queries and responses and modifies the format and content of the query and response to confirm with the requirements of the application server and each of the client computers. In such a manner each client computer can operate and communicate with the communication server using differing formats and still effectively communicate with the application server.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a networked computer environment showing a known relationship between a plurality of client computers and a plurality of servers as is known in the prior art;

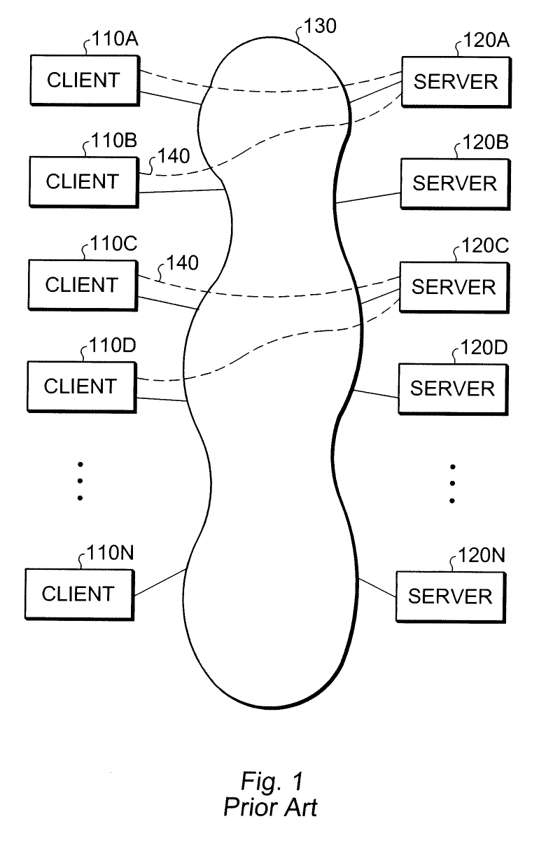

FIG. 2 is a high level block diagram of a system for collaborative web-based computing according to an embodiment of the present invention;

FIG. 3 is a method embodiment for conducing a collaborative web-based computing session according to the present invention; and

FIG. 4 is a method embodiment for simultaneously and collaboratively interacting with an application server according to the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF EMBODIMENTS

Disclosed hereafter by way of example are systems and methods for collaborative web-based computing. According to an embodiment of the present invention, a collaborative web-based system including a plurality of client computers, a communication server, and an application server create an environment in which each of the client computers can simultaneously interact with, and receive data from, the application server.

Specific embodiments of the present invention are hereafter described in detail with reference to the accompanying Figures. Like elements in the various Figures are identified by like reference numerals for consistency. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

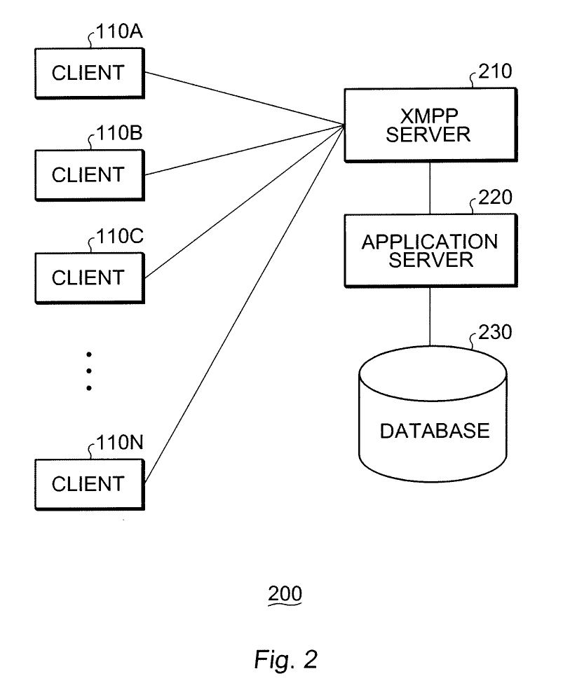

FIG. 2 shows a high level block diagram of a system 200 for collaborative web-based computing according to an embodiment of the present invention. As shown, a plurality of client computers 110n are communicatively coupled to a XMPP server 210. This coupling can be via a wide area network (not shown) such as the Internet or other networking structures as is known to one skilled in the relevant art. Indeed the modules presented in FIG. 2 represent a high level depiction of the functionality of the invention and are not to be considered controlling as to the actual distribution of the modules necessary for the invention to be implemented. As is known in the art of distributed computing, functionalities of one or more particular modules, engines, components, and the like can be distributed among a plurality of networked computers without diminishing from the functionality of the invention.

Interposed between a database 230 and the XMPP server 210 is an application server 220. The database 230 is a repository of data that can be accessed by the application server 230. The database may comprise a plurality of storage mediums or be a portion of a storage area network that includes data which the application server 220 can access. As will be understood by one skilled in the art of data storage, the database 230 can be either a light weight directory protocol based storage system or a relational database and may reside on storage media such as magnetic disks, flash memory, tape, optical disks, and the like. The database 230 serves as a central repository of persistent data used while the application server is in operation. Upon completion of the collaborative session, data utilized by the application server is either persistently retained in the database 230 or transferred to another persistent storage medium.

The XMPP server 210 (also known as a Jabber server) is, according to one embodiment of the present invention, an open sourced, XML-inspired protocol server for near real time, extensible instant messaging (“IM”) and presence information (a.k.a. buddy lists). This protocol is extensible enabling features such as Voice over IP and file transfer signaling. The XMPP network of the present invention is server-based (i.e. clients do not talk directly to one another) and decentralized; by design there is no central authoritative server. Unlike other protocols, XMPP is based on open standards.

Although XMPP is not wed to any specific network architecture, it is usually implemented via a client-server architecture as shown in FIG. 2. As shown, a client computer 110 utilizing XMPP accesses an application server 220 over a terminal control protocol connection. Furthermore, the XMPP server 210 and the application server 220 communicate with each other over TCP connections according to this embodiment.

Each client computer 110 can connect simultaneously to the XMPP server 210 (and thus the application server 220) on behalf of an authorized client. Each client computer 110 is differentiated to the XMPP server 210 by a unique resource identifier. Communication between the client computers 110, the XMPP server 210, and the application server 220 is via eXensible markup language remote procedure calls (“XML-RPC”). XML-RPC is a remote procedure call protocol which uses XML to encode its calls and HTTP as a transport mechanism.

For the purposes of the present invention shown in FIG. 2, the following discussion is intended to provide a brief general description of a suitable computing environment in which the invention may be implemented. Although not required, the invention will be described in the general context of computer-executable instructions, such as program modules, being executed by a computer or server. Generally, program modules include routines, programs, objects, components, data structures, and the like that perform particular tasks or implement particular abstract data types. Moreover, those skilled in the art will appreciate that the invention may be practiced with other computer system configurations, including hand-held devices, multi-processor systems, microprocessor-based or programmable consumer electronics (including “smart” appliances in the home, cellular phones, personal digital assistants or “PDAs”, dashboard devices in vehicles, etc.), end-user workstations, network PCs, minicomputers, mainframe computers, and the like.

The invention may also be practiced in distributed computing environments where tasks are performed by remote processing devices that are linked through a communications network. In a distributed computing environment, program modules may be located in both local and remote memory storage devices.

An exemplary system for implementing the present invention includes a general purpose computing device in the form of a conventional personal computer or the like, including a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read-only memory (ROM) and random access memory (RAM). A basic input/output system (BIOS), containing the basic routines that help to transfer information between elements within the computer, such as during start-up, is stored in ROM. The computer may further include a hard disk drive for reading from and writing to a hard disk, a magnetic disk drive for reading from or writing to a removable magnetic disk, and an optical disk drive for reading from or writing to a removable optical disk such as a CD-ROM or other optical media. The hard disk drive, magnetic disk drive, and optical disk drive are connected to the system bus by a hard disk drive interface, a magnetic disk drive interface, and an optical drive interface, respectively. The drives and their associated computer-readable media provide non-volatile storage of computer readable instructions, data structures, program modules, and other data for the personal computer. Although many computing environments employ a hard disk, a removable magnetic disk, and a removable optical disk, it should be appreciated by those skilled in the art that other types of computer readable media which can store data that is accessible by a computer, such as magnetic cassettes, flash memory cards, digital video disks, Bernoulli cartridges, RAMs, ROMs, and the like may also be used in the exemplary operating environment.

A number of program modules may be stored on the hard disk, magnetic disk, optical disk, ROM or RAM, including an operating system, one or more application programs, other program modules and program data including an XMPP module to facilitate communication with the XMPP server. A user may enter commands and information into the computer through input devices such as a keyboard and pointing device. Other input devices may include a microphone, joystick, game pad, satellite dish, scanner or the like. These and other input devices are often connected to the processing unit through a serial port interface 46 that is coupled to the system bus, but may be connected by other interfaces, such as a parallel port, game port or universal serial bus (USB). A monitor or other type of display device is also connected to the system bus via an interface, such as a video adapter. In addition to the monitor, personal computers typically include other peripheral output devices (not shown), such as speakers and printers.

As is described herein, the computer may operate in a networked environment using logical connections to one or more remote computers. The remote computer may be another personal computer, a server, a router, a network PC, a peer device or other common network node, and typically includes many or all of the elements described above relative to the computer. Logical connections include a local area network (LAN) and a wide area network (WAN) such as the Internet. Such networking environments are commonplace in offices, enterprise-wide computer networks, Intranets, and the Internet.

Such networks may also include mainframe computers or servers, such as a gateway computer (such as the XMPP server 210) or an application server (which may access a data repository 230). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device (such as data repository 230). The gateway computer may be implemented utilizing a variety of architectures consistent with the present description of the invention.

Those skilled in the art will appreciate that the gateway computer may be located a great geographic distance from the network, and similarly, the devices may be located a substantial distance from the network. The devices may connect to the wireless network using a networking protocol such as the Transmission Control Protocol/Internet Protocol (“TCP/IP”) over a number of alternative connection media, such as cellular phone, radio frequency networks, satellite networks, etc. The wireless network preferably connects to the gateway using a network connection such as TCP or UDP (User Datagram Protocol) over IP, X.25, Frame Relay, ISDN (Integrated Services Digital Network), PSTN (Public Switched Telephone Network), etc. The devices may alternatively connect directly to the gateway using dial connections. Further, the wireless network and network may connect to one or more other networks in an analogous manner.

Embodiments of the present invention may be implemented in software. Software programming code which embodies the present invention is typically accessed by a microprocessor of a computer from long-term storage media of some type. The code may be distributed on such media, or may be distributed from the memory or storage of a computer system over a network of some type to other computer systems for use by such other systems. The techniques and methods for embodying software programming code in memory, on physical media, and/or distributing software code via networks are well known and will not be further discussed herein.

When implemented in software, the present invention can be implemented as one or more computer software programs. The software can be implemented using an object-oriented programming language but may be implemented using a high level language such as C, C+, and others known in the art.

The system 200 for collaborative web-based computing shown in FIG. 2 enables multiple users to contribute to, edit, and manipulate the same application simultaneously. According to one embodiment of the present invention, a session is created at the application server 220 by a client computer 110. Using XMPP, the client computer 110 communicates to the XMPP server 210 to establish a channel. With a channel established, the XMPP server 210 interacts with the application server 220 to initiate a session.

According to an embodiment of the present invention, an Extensible Markup Language (“XML”) socket connection is established from the application server 220 to the XMPP server 210. Messages are encoded in XML-RPC and sent through an application program interface (“API”). The API registers all functions for which the embedded application wishes to listen. The API handles building the message and sending it out to the XMPP server 210. The API also receives messages, breaks them out of the XMPP format, checks against the registered functions and calls the appropriate function modules when necessary. All clients 110 and the application server 220 have embedded within their system this API. According to one embodiment of the present invention, this API registers a set of message ID's that map to functions in the content portion of the message. The API controls handling messages and encoding and decoding them and what kind of things need to be sent with the messages. Message ID's are embedded in the message and upon receiving a message the corresponding function, for example, is called. In addition and according to another aspect of the present invention security tokens are sent with the message and IDs that specify what command it is in that message so that the map only accepts things that it's registered to understand.

Rather than access data found on the client computer 110, the application server seeks data from an independent database 230 or data repository under the direction of the client computer 110 initiating the session. For example, a client computer can begin a collaborative mapping session by contacting an appropriate application server 230 via a XMPP server 210. The application server 230, upon receiving the request to initiate a session, accesses a database having a repository of images (maps) for use by the application.

Once the session is up and running, the client computer 110 can send out invitations to other client computers to join the session or, according to another embodiment of the present invention, the XMPP server can push notifications to previously identified clients that a session has been initiated and determine whether they would like to participate in the session. Alternatively, the XMPP server 210 can broadcast an announcement to a predetermined list of client computers 110n that a session has been initiated.

Each client 110 is logged into the XMPP server 210 with the same account and unique resource identifier as established by the host. Each client listener 110 is also logged in to a single conference room on the XMPP server 210. Messages can be sent directly to a user of a client machine via unique resource ID or to the conference room where all listeners will receive the message. Messages from the application server 220 are separate from the actual data. This allows the application server 220 and/or client 110 to send messages directly to a single user or to all clients 110 listening in the defined conference room.

Data is retrieved from a database 230 via a proxy on the server that checks against a local cache and returns the data to the application server 220, according to one embodiment. When data is not present in the local cache, the application server 220 will request data from the database 230, cache the data on the local hard disk, and then return to the application. Data is typically returned in small lightweight packets to improve performance of low bandwidth.

When the application server 220 receives a message from the XMPP server 210 it hands off the message to a dispatch API (written in any language) that determines how to handle the message. A method application as known in the art in any server based language can be called to perform actions using the data in the message to include connecting to the database 230 to retrieve data. The data is then returned to the application server 220 directly or through the HTTP protocol, encoded back into XML-RPC, and sent back to the XMPP server 220 as a message.

To better understand the present invention consider the following example of a collaborative session regarding the rendering and manipulation of a map. A leader (host) opens a session at a host computer which is coupled to a network possessing a message server. In doing so the host communicates with a database to download spatial data which is then applied to an application serve via scripts to form a graphical representation, i.e. a map. The map is placed on the session by the dispatch module using XMPP in a form that can ultimately be conveyed to the messaging server, the XMPP server. Others (clients) see a list of available sessions via XMPP server request module which is resident on each client machine and communicatively coupled to the XMPP server via separate channels.

The leader queries for all buildings relevant to the viewing area of the map. The query request is encoded by XMPP module into XML-RPC format and sent through the messaging server to the account used by the server-side bot. The server-side bot decodes the XMPP message from XML-RPC into local code and passes the local code to the dispatch module. The dispatch module reads the local code and calls the appropriate application server component. The application server uses the data in the local code to access the database, return all relevant building data, then encode the data as XML-RPC using the server-side XML-RPC marshall. The XML-RPC code is sent back to the server-side bot to create an XMPP message to send back to the XMPP server. The XMPP server forwards the message back to the host computer and is there received by the XMPP module resident on the client. The XMPP module decodes the XML-RPC message to local code which the map then uses to display the building data on the map. The leader can then send this data to all other clients in the session. The map passes the building data to the module which encodes into XML-RPC. The XMPP module then sends the map as a XMPP message to the session conference room on the XMPP server. The messaging server forwards the message to all occupants of that conference room. Each client receives the message through their XMPP module, decodes the message to local code, and at each clients the map displays the building data.

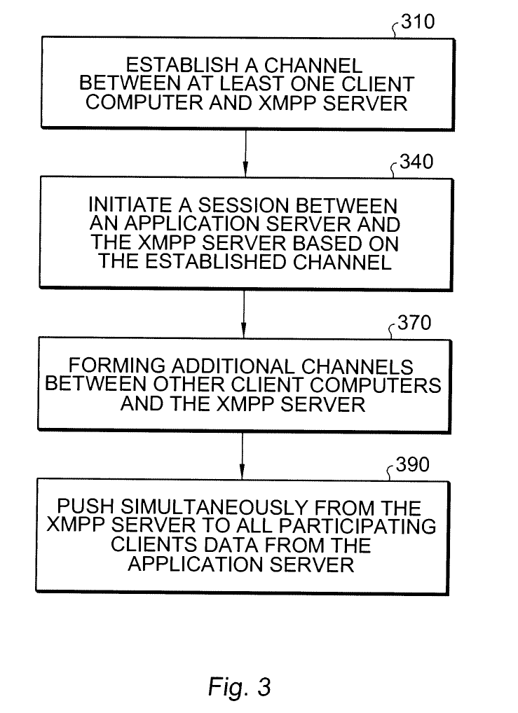

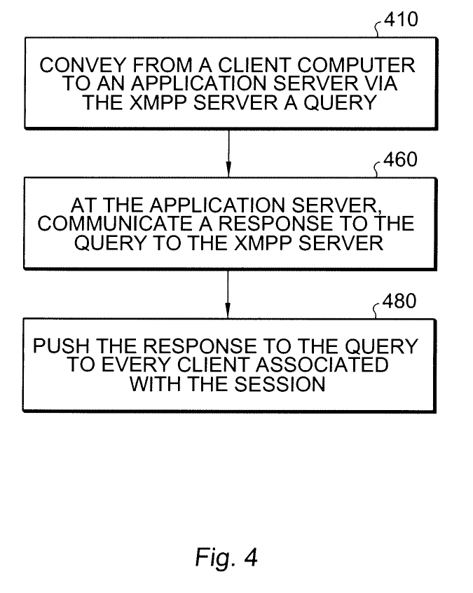

FIGS. 3 and 4 are flowcharts illustrating methods of implementing an exemplary process for collaborative web-based computing with FIG. 3 being directed toward a method embodiment for initiating a collaborative web-based computing session. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

As shown in FIG. 3, the process begins with the establishment 310 of a channel between a client computer 110 and the XMPP server 210. With the channel established, a session on the application server 220 is initiated 340 using data gained from the database 230 that is independent of the client computers 110. Thereafter, other client computers 110 join 370 the session by establishing additional channels with the XMPP server 210. Data generated by the application server 220 is thereafter pushed 390 to all participating client computers 110 simultaneously.

Thus in the previous example, a single client, in this case a user operating a laptop computer, sends a request to an application server 220 for the purpose of creating a collaborative mapping session. The XMPP server 210 establishes a channel to both the client computer 110 and the application server 220 and delivers the session request. The application thereafter initiates a mapping session and generates a map based on parameters provided by the client computer 110.

The application server 220 is operative to create its map using an image repository or database 230 independent of the client computer 110. In this case the client computer 110 may have requested that the map be a 2 mile radius map of the city of Denver, Colo. centered at the geographic center of town. The web-based mapping application on the mapping server 220 retrieves necessary imagery from a database 230 to render the map. Once rendered by the application server 230, the data is automatically pushed down to the client computer 110 initiating the session.

Other client computers joining the session are automatically provided with the same rendering of the same map as seen by the initiating client computer. Assume for the purpose of this example that two other client computers join the session, a user accessing network data via a personal data assistant (“PDA”) and a user operating a terminal at a traffic control center in one of Denver's municipal buildings.

Rather than each client polling the server data in a typically pulling fashion as is well known in the art, clients, according to embodiments of the present invention, are given data, pushed data, without initiating any type of data request. The existence of a dedicated channel between each client computer 110 and the XMPP server 210 enables a free flow of data that reduces latency and is scalable beyond the typical communication scenario. As one skilled the art will recognize latency is the time that expires as a node in a network responds to an inquiry. Latency is driven by many factors including bandwidth in the communication network and the ability for a server to respond to inquiries. As inquiries mount, a server can become overloaded forcing the response time to increase, thus increasing latency. In addition when the network bandwidth is insufficient, despite the server being ready to respond, there is no way to convey the results since the means for transporting the results is occupied with other transmissions. Thus the results must wait until an avenue within the existing bandwidth exists to conduct the transmission. In a pulling type of system, each client must submit a request to a server, the server must receive the request from each client and then push the response. This includes requests to update the data or rendering, which typically, according to the prior art, occur several times per second. In the present invention, the clients are not sending and the server is not actively receiving requests from every participating client. Only those clients submitting changes are issuing requests to the application server 220. Thus the utilization of the existing bandwidth is reduced as is the tasking on the server to respond.

Scalability is a closely related topic regarding the ability to add additional clients to an existing system. Since the present invention pushes data to all client computers 110 without receiving a request for such data, the present invention is scalable well beyond that of a convention design. The existing bandwidth is more efficiently used, as are the resources of the application server 220, to respond to inquires to change the data.

Thus the user viewing the map on the PDA, the visual display unit or terminal in the municipal building, and the laptop, and all other client computers that join the session, all see the same image rendered by the same application. Turning in addition to FIG. 4, a process to collaborate with the application server according to an embodiment of the present invention is shown. With a session initiated, each of the participating client computers 110 can interact with the application server 220 simultaneously. Queries made by a client computer 110 are conveyed 410 to the application server 220 via the XMPP server. The queries presented to the application server 220 may be in the form of a request for additional information or a submission of additional data from which the application server 220 can update the session. Returning back to the previous example of a mapping session, one of the client computers can initiate a request for current traffic flows on all streets in downtown Denver.

The application server, upon receiving the query, forms 460 a response and communicates that response to the XMPP server. The XMPP server 210 broadcasts or pushes 480 the response to each of the plurality of participating client computers 110 automatically. In the case of the current example, all three users participating in this session will receive the same response from the XMPP server simultaneously. Each user's map will now include traffic data for the depicted region.

According to an embodiment of the present invention, any of the client computers 110 participating in the session can simultaneously submit queries to the application server 110 so as to modify or alter the current rendering. Thus in the present example, the user on the PDA viewing the traffic map of downtown Denver notes that a traffic backup on a particular intersection is due to an automobile accident. The user inputs the data on the PDA using the PDA interactive browser capability. The information is immediately conveyed to the XMPP server and thereafter to the application server. The rendering of the traffic map is updated and pushed down to all participating clients.

Seeing that an accident has been identified at a particular intersection, the user on the client computer at the traffic center alerts emergency services and responds to the application server 220 that help is on the way and provides alternate routes to minimize congestion. Both the user on the laptop and the PDA receive the new data simultaneously.

According to one embodiment of the present invention, data conveyed between differing architectures is harmonized by a parser located on the XMPP server 210. The communication protocols of a PDA versus a laptop computer versus a thick client such as a mainframe computer system are vastly different. For a PDA to operate efficiently and as equal partners with thick clients, the communication language and its content must be parsed. According to one embodiment of the present invention, the queries received by the XMPP server 210 to be conveyed to the application server 220 and the data pushed down to each of the client computers 110 is parsed so as to comply with the requirements of the receiving entity without any loss of content.

In addition, client computers experiencing a temporary loss of connectivity can reconnect to the session without fear that in their absence data has been communicated that is not recoverable. As the user on the PDA travels, the wireless link to the PDA is lost resulting in a loss of connectivity. According to an embodiment of the present invention, data sent to each client computer includes an identifier and conveys back to the application XMPP server 210 an acknowledgement of receipt when a piece of data pushed down to the client has been received. Furthermore, the data is cached such that should one or more of the participating client computers 110 experience a temporary loss of connectivity, the rendering of the map can be reestablished to its current state upon a reconnection to the network. Here the PDA regains connection to the web and notes that in the period of being disconnected three updates have occurred in which the application server via the XMPP server has pushed down additional data. However, the XMPP server recognizes that the receipts for those three updates have not been acknowledged, by the PDA client computer. Each piece of information is conveyed to the client computer 110 (the PDA) so as to make the rendering at each participating client computer 110 consistent with that of the application server.

Another embodiment of the present invention resolves conflicts between two or more client computers attempting to modify the same aspect of an application. For example, assume that both the user on the PDA client computer and the user on the laptop are attempting to adjust the size of the map at the same time.

When a conflicting query from two or more client computers 110 is received by the application server, the inputs are queued based, according to one embodiment of the present invention, on the time of the arrival. Invariably one input will arrive before another. One approach of the present invention is to implement the first arriving request or inquiry and communicate to the user initiating the subsequent request that the application server is currently addressing a previously submitted inquiry and cannot respond to the submitted request. Once the first request has been acted upon by the application server 220 and the application server 220 has pushed down the modification to all of the client computers 110 via the XMPP server 210, the other client computers can submit additional changes.

According to another embodiment of the present invention, a priority scheme of client computers can be established and maintained in the database 230. Upon two or more conflicts existing, the request with the highest priority is initiated and a message to the other requestor(s) can be generated indicating that their request has been denied. Alternatively, and according to yet another embodiment of the present invention, a system of privileges can be established so that only client computers with certain privilege levels can make or facilitate certain session wide changes. For example, the client computer 110 at the traffic control center may have the ability to modify any data regarding the rendering of the map including size, center, attributes, content, etc, while others, such as PDA users, may only be able to add content to the map and not control the attributes or the center of the map.

To accomplish this type of conflict resolution in a collaborative web-based computing system, an embodiment of the present invention creates individual data files associated with each client computer participating in the session. The files can be created at the application server 220, the XMPP server 210 or the database 230 and manage the changes and inputs submitted by each of the client computers 110 participating in the session. The files or folders would be synchronized but inputs would be based on the individual client computer association. Rather than overwriting changes submitted by another client computer 110, a notification can be sent out when a change conflicts with a current modification.

Upon receiving a modification, the application server would notify each folder that a modification of a certain portion of the data is ongoing. That section would be marked accordingly. When another request arrives to modify the same section, the folder receiving that request will recognize a conflict and transmit a message back to the sending client computer that a modification is ongoing and to submit the request at a later time.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with collaborative web-based computing, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

We claim:

1. A system for collaborative web-based computing, the system comprising:
a plurality of client computers wherein each client computer includes an extensible messaging and presence protocol (“XMPP”) module;
an application server;
a database communicatively coupled to the application server; and
a XMPP server configured to conduct XMPP communications communicatively coupled to each of the plurality of client computers and to the application server wherein, upon establishment of a channel with the XMPP server by at least one of the plurality of client computers, the XMPP server forms a session with the application server and thereafter automatically pushes data from the application server to each of the plurality of client computers simultaneously.

2. The collaborative web-based computing system of claim 1 wherein each of the plurality of client computers establishes a channel to the XMPP server.

3. The collaborative web-based computing system of claim 2 wherein the channel to the XMPP server is via a web browser.

4. The collaborative web-based computing system of claim 2 wherein establishing a channel to the XMPP server is in accordance with authorization policies managed by the application server.

5. The collaborative web-based computing system of claim 1 wherein the application server is configured to execute a mapping application.

6. The collaborative web-based computing system of claim 1 wherein the application server is configured to execute a web-based application using a common data repository.

7. The collaborative web-based computing system of claim 1 wherein the database includes a plurality of implementation policies implemented by the application server.

8. The collaborative web-based computing system of claim 1 wherein data being pushed down to the plurality of client computers is independent of any data requests made by the plurality of client computers.

9. The collaborative web-based computing system of claim 1 wherein, responsive to at least one of the plurality of client computers disconnecting from the XMPP server, data being pushed down to the plurality of client computers by the XMPP server while the at least one of the plurality of client computers is disconnected is cached such that responsive to reestablishment of communication with the at least one of the plurality of client computers, cached data is automatically pushed to the at least one of the plurality of client computers.

10. The collaborative web-based computing system of claim 1 wherein communication among the XMPP server, the application server and the plurality of client computers uses extensible markup language remote procedure call protocol.

11. The collaborative web-based computing system of claim 1 wherein an ability to manipulate data being processed by the application server by each of the plurality of client computers participating in the session varies according to a plurality of predefined authorization levels.

12. A method for collaborative web-based computing implemented by a machine operative to execute a computer program of instructions wherein said program of instructions comprises a plurality of program codes, said program of instructions comprising:
one of said program codes for establishing a communications channel between a first client computer and an application server via a communication server, said communications server configured to conduct extensible messaging and presence protocol (“XMPP”) based communications;
one of said program codes for initiating an application session on the application server;
one of said program codes for receiving a request from a second client to join the session;
one of said program codes for forming an additional channel between the communications server and the second client responsive to the request to join the session being approved;
one of said program codes for communicating to the application server from the first client computer a query;
one of said program codes for conveying to the communications server a response to the query; and
one of said program codes for pushing a response to the query to each of the first client computer and to the second client computer simultaneously.

13. The method for collaborative web-based computing of claim 12 wherein the communications server includes a parsing engine configured to modify queries from client computers so as to be compatible with the application server.

14. The method for collaborative web-based computing of claim 12 wherein the query is modified by a parser engine to a format compatible with the application server.

15. The method for collaborative web-based computing of claim 12 wherein the response pushed to the first client computer is modified by the communications server to be compatible with the first client computer and the response pushed to the second client computer is modified by the communications server to be compatible with the second client computer.

16. The method for collaborative web-based computing of claim 12 further comprising program code for communicatively coupling the application server with a database wherein the database includes application specific data.

17. A computer-readable storage medium tangibly embodying a program of instructions executable by a machine wherein said program of instruction comprises a plurality of program codes for collaborative web-based computing, said program of instruction comprising:
program codes for establishing a communications channel between a first client computer and an application server via a communication server, said communications server configured to conduct extensible messaging and presence protocol (“XMPP”) based communications;
program codes for initiating an application session on the application server;
one of said program codes for receiving a request from a second client to join the session;
program codes for forming an additional channel between the communications server and the second client responsive to the request to join the session being approved;
program codes for communicating to the application server from the first client computer a query;
program codes for conveying to the communications server a response to the query; and
program codes for pushing a response to the query to each of the first client computer and to the second client computer simultaneously.

18. The computer-readable storage medium of claim 17 wherein the response pushed to the first client computer is modified by the communications server to be compatible with the first client computer and the response pushed to the second client computer is modified by the communications server to be compatible with the second client computer.
